(19) United States
(12) Patent Application Publication
(10) Pub. No.: US 2014/0216032 A1
(43) Pub. Date: Aug. 7, 2014

(54) SOLAR DIRECT STEAM GENERATION POWER PLANT COMBINED WITH HEAT STORAGE UNIT

(71) Applicant: Alexander Levin, Binyamina (IL)

(72) Inventor: Alexander Levin, Binyamina (IL)

(21) Appl. No.: 13/757,971

(22) Filed: Feb. 4, 2013

(51) Int. Cl. F03G 6/06; F01K 1/10

(52) U.S. Cl. CPC F03G 6/065; F01K 1/10
USPC 60/641.15; 60/659

(57) ABSTRACT

The invention proposes a concentrating solar power plant, which includes a heat storage unit allowing operation of the power plant for some hours on the base of accumulated heat. An important feature of the plant constitutes its ability to operate with direct steam generation (DSG) immediately in the concentrating solar collectors.

Heat charging of the heat storage unit are performed with changing temperature of superheated steam, which circulates via the heat storage unit and a sub-field of the concentrating solar collectors; this sub-field serves solely for temperature elevation of the circulating superheated steam.

Heat discharging of the heat storage unit is executed by heating the circulated superheated steam, which is delivering from a mixer-evaporator.

This mixer-evaporator serves, in turn, for evaporation of condensate obtained in a condenser of a turbine unit; the evaporation process is based on utilization of sensible heat of the superheated steam.

### STATEMENT REGARDING FEDERALLY SPONSORED RESEARCH

Not applicable.

### FIELD OF THE INVENTION

This invention relates to the field of concentrating solar power plants (CSP).

### BACKGROUND OF THE INVENTION

The invention proposes a concentrating solar power plant, which includes a heat storage unit allowing operation of the power plant for some hours on the base of heat accumulated in a heat storage unit. It is widely recognized that application of concentrating solar collectors with direct steam generation (DSG) instead of thermal oil allows significant diminishment of electricity generation cost in the concentrating solar power plants and, at the same time, to achieve higher efficiency.

Detailed discussion regarding solar power plant with direct steam generation is presented in an article: J. Birnbaum et al. “A Concept for Future parabolic Trough Based Solar Thermal Power Plant”, PREPRINT—ICPWSXV, Berlin, Sep. 8-1, 2008.

Heat accumulation in such concentrating solar power plants presents a serious problem.

U.S. Pat. No. 7,331,178 describes a generating facility, which is provided for generating electricity from both solar and non-solar energy sources. The solar generating portion of the facility includes capability to directly generate electricity from solar insolation, or to store the solar energy in a tangible medium, including stored heat, or solar generating fuel. The generating facility is configured to generate electricity simultaneously from both solar and non-solar sources, as well a solely from immediate solar insolation and from solar energy stored in a tangible medium.

U.S. Pat. No. 7,836,695 describes a solar energy system includes a plurality of concentrating dishes and a plurality of heated air collectors. Each collector receives directed rays of sunlight from one of the concentrating dishes. A heated air distribution assembly collects air heated in the collectors. A thermal storage assembly is operably connected to the heated air distribution assembly and has a plurality of thermal storage elements. A steam generator is operably connected to the heated air distribution assembly and the thermal storage assembly. A steam turbine is operably connected to the steam generator.

U.S. Pat. No. 7,845,172 describes a generating facility, which is provided for generating electricity from both solar and non-solar energy sources. The solar generating portion of the facility includes capability to directly generate electricity from solar insolation, or to store the solar energy in a tangible medium, including stored heat, or solar generating fuel. The generating facility is configured to generate electricity simultaneously from both solar and non-solar sources, as well a solely from immediate solar insolation and from solar energy stored in a tangible medium.

U.S. Pat. No. 7,954,321 describes a method for storing heat from a solar collector CSTC in Concentrating Solar Power plants and delivering the heat to the power plant PP when needed. The method uses a compressed gas such as carbon dioxide or air as a heat transfer medium in the collectors CSTC and transferring the heat by depositing it on a bed of heat-resistant solids and later, recovering the heat by a second circuit of the same compressed gas. The storage system HSS is designed to allow the heat to be recovered at a high efficiency with practically no reduction in temperature.

U.S. Pat. No. 8,087,245 describes a method of generating electricity under a Rankine thermodynamic cycle; the method includes: a) providing a solar concentrator electric plant; b) generating saturated water vapor at a pressure of at least 96 bar utilizing a two-dimensional solar concentrator from water; c) subsequent to step b) generating overheated water vapor utilizing a three-dimensional concentrator from the saturated water vapor; d) subsequent to step c) generating electricity using a steam turbine from the overheated water vapor; e) in a first operating condition, flowing the water in a continuous cycle through a piping system so as to flow in sequence through the two-dimensional solar concentrator, the three-dimensional solar concentrator, the turbine and back to the two-dimensional solar concentrator; and f) in a second operating condition, flowing the water in a continuous cycle through a piping system so as to flow in sequence through the two-dimensional solar concentrator, through a back up fossil fuel generator adapted to provide backup heat to the water, through the turbine, and back to the two-dimensional solar concentrator, bypassing the three-dimensional solar collector.

U.S. Patent Application No. 20120102950 describes a concentrated solar power (CSP) plant, which comprises: a solar field; a gas turbine; a steam turbine system; and a thermal transfer system configured to store and/or transfer solar heat energy; wherein the thermal transfer system is downstream of the gas turbine system; and wherein the thermal transfer system is coupled to the gas turbine and to the steam turbine system.

U.S. Patent Application No. 20110252797 describes a gas turbine plant associated with a solar thermal electric generation system that has a heat receiver and receives heat from the sun, a gas turbine having a compressor and a turbine which operates with an operating fluid compressed by the compressor and heated by the heat receiver, a temperature sensor which detects heat from the sun, an auxiliary driving device which is driven based on the temperature of the heat detected by the temperature sensor, and which starts the gas turbine, and a generator which converts kinetic energy generated as a result of the rotation of the turbine into electric energy.

U.S. Patent Application No. 20110131988 proposes a solar-fossil-fuel-hybrid power plant with higher power generation efficiency; this solar-fossil-fuel-hybrid power plant has heating working fluid with a concentrating solar field by directing a first portion of a steam turbine drive working fluid from an economizer of a heat recovery steam generator (HRSG) of the solar-fossil-fuel hybrid power plant into a concentrated solar power (“CSP”) field where the first portion of the steam turbine drive working fluid is heated to a predefined temperature and pressure above that which is in a CSP inlet to the steam boiler while a second portion of the steam turbine drive working fluid is directed from the economizer to a steam boiler and the first portion of the steam turbine drive working fluid is combined with the second portion of the work fluid at the inlet.

Patent Application WO/2012/159924 describes a solar thermal power plant 20 comprising a solar radiation receiver 28 mounted on a tower 22 surrounded by a heliostat field 24 to receive solar radiation reflected by heliostats 26 forming the heliostat field 24. The power plant 20 comprises a power generation circuit 30 including a steam turbine for driving an electrical generator to produce electrical power, and water in the power generation circuit 30 is capable of being heated directly by solar radiation reflected onto the solar radiation receiver 28 by the heliostat field 24 to generate steam to drive the steam turbine. The power plant 20 also comprises an energy storage circuit 36 including a thermal energy storage fluid, such as molten salt, which is capable of being heated directly by solar radiation reflected by the heliostat field 24. A heat exchanger 44 is also provided for recovering thermal energy from the thermal energy storage fluid in the energy storage circuit 36; the recovered thermal energy may then be used to generate steam to drive the steam turbine.

### SUMMARY OF THE INVENTION

This invention proposes a novel design of a concentrating solar power plant including combination of a field of concentrating solar collectors with a heat storage unit.

The field of the concentrating solar collectors of the power plant is subdivided into three sub-fields:

The first one serves for pre-heating and evaporation of high-pressure water with obtaining saturated steam; the second one serves for superheating the obtained saturated steam, and the third one serves for heating dry steam, which circulates via the heat storage unit with charging heat in it during a charging mode.

The heat storage unit can be of recuperative or regenerative types.

In the discharging mode of the heat storage unit, superheated steam with relatively low temperature is passing via this heat storage unit with elevation its temperature; thereafter, this superheated steam is mixed with condensate with reduction its temperature and increasing its volume; the obtained superheated steam is split into two streams: the first one is directed in the steam turbine, which actuates an electrical generator, and the second one is directed into the heat storage unit for further elevation its temperature.

The recuperative versions of the heat storage unit can operate on a principle of sensible heat charging and discharging from a liquid medium flowing via a recuperative heat exchanger.

One regenerative version of the heat storage unit comprises a packing containing a phase change material, which change its state from solid to liquid and vice versa at a proper temperature. Another version of the regenerative heat storage unit comprises a solid packed bed system with application of solid packing elements.

It should be emphasized that the second and third sub-fields of the concentrating solar collectors operate with different temperatures of steam emerging these sub-fields, when the temperature of steam emerging the third sub-field of the concentrating solar collectors is preferably higher than the temperature of steam emerging the second sub-fields.

Therefore, these sub-fields can be designed in a different manner; for example, the concentrating solar collectors of the first and second sub-fields are designed as concentrating solar collectors of a trough type and the concentrating solar collectors of the third sub-field is designed as a heliostat-tower solar collector.

The outlets connectors of both second and third sub-fields of the concentrating solar collectors can be in fluid communication with backups heaters energized by combustible fuel, which provides required temperatures and superheating levels of steam directed into the turbine—electrical generator unit and into the heat storage unit.

### BRIEF DESCRIPTION OF THE SEVERAL VIEWS OF THE DRAWING

FIG. 1 shows a general layout of a concentrating solar power plant, which includes a heat storage unit.

FIG. 2 shows a general layout of concentrating solar power plant, which includes a deaerator for degassing condensate, which is obtained in a condenser, and backup heaters operating on the base of fuel combustion.

### DESCRIPTION OF PREFERRED EMBODIMENTS

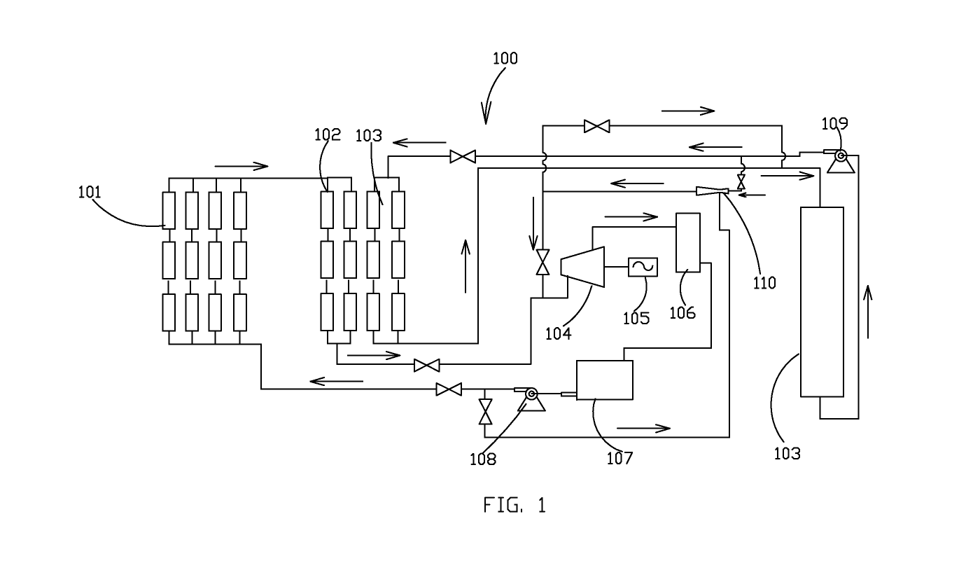

FIG. 1 shows a general layout of a concentrating solar power plant 100, which includes a heat storage unit.

It comprises: a first sub-field 101 of concentrating solar collectors, which serves for generation of saturated steam; a second sub-field 102 of concentrating solar collectors, which serves for superheating the saturated steam generated in the first sub-field 101; a third sub-field 103 of concentrating solar collectors, which serves for heating of superheated steam circulating via the sub-field 103 and a heat storage unit 111.

Superheated steam from the second sub-field 102 of the concentrating solar collectors actuates a steam turbine 104; this steam turbine, in turn, actuates an electrical generator 105. Expanded steam from turbine 104 is condensed in condenser 106 and is drained into a condensate reservoir 107.

A high-pressure pump 108 returns the condensate from the condensate reservoir 107 into the first sub-field 101 of the concentrating solar collectors.

At time of absence of solar radiation, blower 109 performs circulation of superheated steam via the heat storage unit 111 and mixer-evaporator 110, which provides mixing of superheated steam emerging the heat storage unit 111 with condensate delivered into mixer-evaporator 110 by the high pressure pump 108.

Superheated steam emerging mixer-evaporator 110 is divided into two streams; its one fraction is delivered into turbine 104 and the second fraction is returned into the heat storage unit 111. It should be noted that the mixer-evaporator 110 is constructed like a common desuperheating tube, but degree of its desuperheating does not provide saturated dry steam at its outlet.

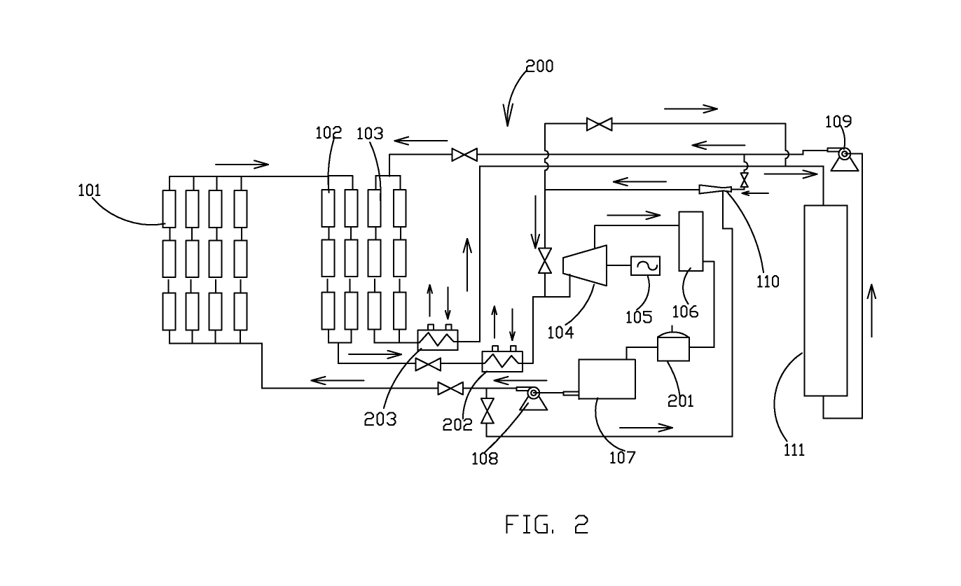

FIG. 2 shows a general layout of a concentrating solar power plant 200, which includes a deaerator 201 for degassing condensate, which is obtained in condenser 106 and backup heaters 202 and 203 operating on the base of fuel combustion.

The concentrating solar power plant 200 comprises same other elements as the concentrating solar power plant 100 and operates in the same manner.

It comprises a first sub-field 101 of concentrating solar collectors, which serves for generation of saturated steam; a second sub-field 102 of concentrating solar collectors, which serves for superheating the saturated steam generated in the first sub-field 101; a third sub-field 103 of concentrating solar collectors, which serves for heating of superheated steam circulating via the sub-field 103 and a heat storage unit 111.

Superheated steam from the second sub-field 102 of the concentrating solar collectors actuates a steam turbine 104; this steam turbine, in turn, actuates an electrical generator 105. Expanded steam from turbine 104 is condensed in condenser 106 and is drained into a condensate reservoir 107.

A high-pressure pump 108 returns the condensate from the condensate reservoir 107 into the first sub-field 101 of the concentrating solar collectors.

At time of absence of solar radiation, blower 109 performs circulation of superheated steam via the heat storage unit 111 and mixer-evaporator 110, which provides mixing of superheated steam emerging the heat storage unit 111 with condensate delivered into mixer-evaporator 110 by the high pressure pump 108.

Superheated steam emerging mixer-evaporator 110 is divided into two streams; its one fraction actuates turbine 104 and the second fraction is returned into the heat storage unit 111.

1. A concentrating solar power plant consisting of:
a heat storage unit;
a field of concentrating solar collectors, which is subdivided into three sub-fields of said concentrating solar collectors; said first sub-field of said concentrating solar collectors serves for pre-heating condensate and direct steam generation with obtaining saturated steam; said second sub-field serves for superheating saturated steam emerging said first sub-fields of said concentrating solar collectors; said third sub-field of said concentrating solar collectors serves for heating of superheated steam with elevation of its temperature, wherein said heat storage unit is charged with heat by superheated steam delivered from said third sub-field of said concentrating solar collectors;
a condensate tank with a high pressure pump providing high pressure condensate;
a mixer-evaporator intended to mix said condensate with superheated steam emerging said heat storage unit during the time of absence of solar radiation with following evaporation said condensate and lowering temperature of said superheated steam delivered into said mixer-evaporator; the stream of said superheated steam is emerging said mixer-evaporator with splitting said stream into two sub-streams, wherein one of said sub-streams is returning into said heat storage unit;
a steam turbine, which as actuated by superheated steam provided from said second sub-field of said concentrating solar collectors at the time of solar radiation and from another sub-stream of said superheated steam emerging said mixer-evaporator during the time of absence of solar radiation;
an electrical generator, which is actuated by said steam turbine;
a condenser serving for condensing expanded steam emerging said steam turbine; condensate obtained in said condenser is drained into said condensate tank;
a blower, which executes circulation of superheated steam through said third sub-field of said concentrating solar collectors and said heat storage unit at the time of solar radiation, and through said heat storage unit and said mixer-evaporator during the time of absence of solar radiation.

2. The concentrating solar power plant as claimed in claim 1, wherein the heat storage unit is constructed as a recuperative heat exchanger on a principle of charging and discharging sensible heat of a liquid medium.

3. The concentrating solar power plant as claimed in claim 1, wherein the heat storage unit is constructed as a regenerative heat exchanger on a principle of charging and discharging sensible heat of solid packed bed.

4. The concentrating solar power plant as claimed in claim 1, wherein the heat storage unit is constructed as a regenerative heat exchanger on a principle of charging and discharging sensible and latent heat of a packed bed, which comprises a phase change material with a proper temperature range of its melting-solidification.

5. The concentrating solar power plant as claimed in claim 1, wherein a temperature of steam emerging the third sub-field of concentrating solar collector is higher than a temperature of steam emerging the second sub-field of the concentrating solar collectors.

6. The concentrating solar power plant as claimed in claim 1, wherein the concentrating solar collectors of the first and second sub-fields are designed as concentrating solar collectors of a trough type and the concentrating solar collectors of the third sub-field are designed as a heliostat-tower solar collector.

7. The concentrating solar power plant as claimed in claim 1, wherein there is a deaerator, which is installed on the pipe line of condensate before its ingress into the condensate tank.

10. The concentrating solar power plant as claimed in claim 1, wherein there is a backup heater operating on the base of fuel combustion; said backup heater serves for pre-heating, evaporation and superheating the condensate; said backup heater operates in line with the first and second sub-fields of the concentrating solar collectors.

11. The concentrating solar power plant as claimed in claim 1, wherein there is a backup heater operating on the base of fuel combustion; said backup heater serves for temperature elevation of superheated steam; said backup heater operates in line with the third sub-field of the concentrating solar collectors.
